(19) United States
(12) Patent Application Publication
(10) Pub. No.: US 2006/0015270 A1
(43) Pub. Date: Jan. 19, 2006

(54) Dynamic unbalance calculating method and dynamic unbalance testing device

(76) Inventor: Katsumi Tsuji, Setagaya-ku (JP)

Correspondence Address: Katsumi Tsuji, 31 24 Soshigaya 4 chome, Setagaya ku Tokyo, 157 0072, JP

(21) Appl. No.: 10/535,438

(22) PCT Filed: Nov. 10, 2003
(86) PCT No.: PCT/JP03/14236

§ 371 Date: May 10, 2005

(30) Foreign Application Priority Data
Nov. 29, 2002 (JP) 2002-382751

(51) Int. Cl. G06F 19/00

(52) U.S. Cl. 702/56

(57) ABSTRACT

The magnitudes and angular positions of dynamic unbalance in rotor are determined by the calculating method of this invention from the original vibration vectors. The original vibration vectors (magnitude and angular position) obtained by measurements using a vibration sensor at bearings supporting the rotor has its specific unbalance calculated from the dynamic unbalance vectors (magnitude, angular position) in the rotor obtained by the vector calculation method on the basis of the ratios of the distances between the bearings to the distance between the two correction planes chosen arbitrarily in the rotor.

### FIELD OF APPLICATION

This invention relates to a calculating method to determine the dynamic unbalance vectors in rotors.

### PRIOR ART

Up to this time, the calculating method to determine the dynamic unbalance in rotor of rotating machines is as follows:

The original vibration vectors (displacement, velocity, or acceleration) are measured at bearings effected by the centrifugal force due to unknown dynamic unbalance in the rotor. Then the machine is stopped and a trial mass is attached on the rotor. Subsequently the machine is ran and the vibration vectors changed by the trial mass are measured. These test runs with trial mass are necessary to repeat at several times. Using the measured quantities, the dynamic unbalance in the rotor can be determined by the calculating with conversion coefficient method and such.

### ABSTRACT OF THE DISCLOSURE

The object of this invention is to eliminate the burdens which the ordinal method needs several times stops to run, disassemblings, attachings with trial mass, reassemblings, retest runs and measurings to detect the changed vibration vectors, and to produce the calculating method to determine the dynamic unbalance in rotor from only the original vibration vectors measured under the initial operating condition without a trial mass.

The feature of this invention is to calculate the dynamic unbalance vectors (magnitudes and directions) in rotor, by the geometric-vector-calculation using the ratios for distance lengths between bearings and the distance length between the correction planes, on the view point of this invention that the vector quantities (displacement, velocity, or acceleration) measured at both bearings under the initial operating condition, corresponding to the centrifugal forces due to the dynamic unbalance of rotor represented at the portions of journals.

### BRIEF DESCRIPTION OF THE DRAWINGS

FIG. 1 shows a image drawing for the example of carrying out the invention.

FIG. 2 shows a example of carrying out the invention by the vector calculation in case of a₁=a₂.

FIG. 3 shows a image drawing for example of carrying out the invention by the vector calculation in case of a₁≠a₂.

FIG. 4 shows a example of carrying out the invention by the vector-computationin case of a₁≠a₂.

### DESCRIPTION OF THE MARKS

a₁, a₂: Length between the correction planes and bearings.
b: Length between the correction planes.
l₁, l₂: Length between the center of gravity and bearings.
B₁,B₂: Bearings supporting the journals of rotating shaft.
L: Length between the bearings
R: Main portion of rotor
G: Gravity-center of rotor
I, II: Correction planes (dynamic balance planes)
X: X-coordinate, basis of angle for rotor
Y: Y-coordinate
Z: Z-coordinate, center of rotating axis (main shaft)

### BEST MODE OF CARRYING OUT THE INVENTION

Followings are the descriptions of a best mode of carrying out the invention taken in connection with the accompanying drawings.

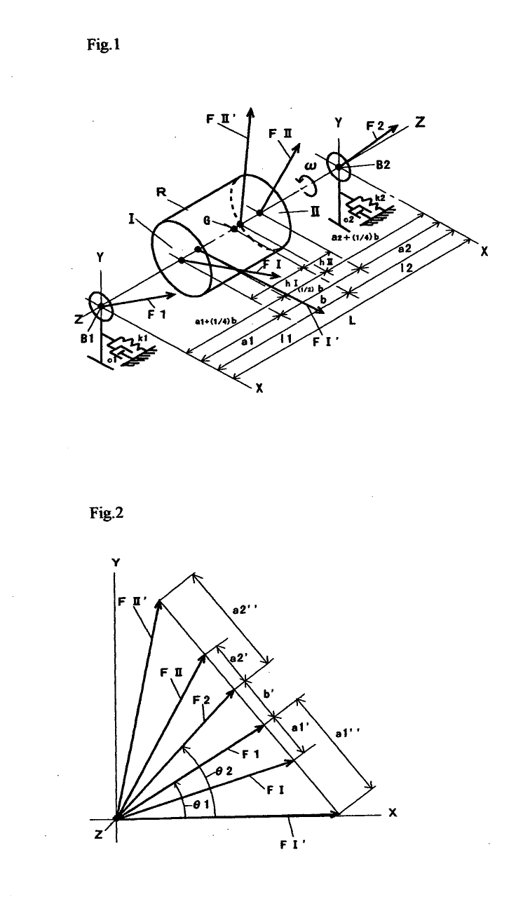

1. FIG. 1 (a three-dimensional drawing) shows a model for the state of that the most general rotor, R, of the rotating machines supported in level by the bearings B1,B2, to be applied the invention

The unbalance centrifugal forces caused by the dynamic unbalance in rotor, transfer to the bearings B1,B2 through the journals of the main shaft (z-coordinate) and the vibrations can be produced on the bearings B1,B2.

For the vibrations on the bearings, the vibration vector quantities (magnitude & direction for displacement, velocity, or acceleration) measured in X-coordinate are X₁,X₂.

In case of that the vibration vectors are the amplitudes of displacements X₁, X₂ [cm], the equation of motion for the forced vibrations of the centrifugal forces, F₁, F₂ acting to the bearings B1,B2 which due to the unbalance in rotor, can be expressed by the following differential equation:

$${M}_{1 , 2} \frac{{ⅆ}^{2} {x}_{1 , 2}}{ⅆ {t}^{2}} + {c}_{1 , 2} \frac{ⅆ {x}_{1 , 2}}{ⅆ t} + {k}_{1 , 2} {x}_{1 , 2} = {F}_{1 , 2} cos ω t [ N ] \qquad 1 \text{-} 1$$

where,
M_{1,2}: inertia mass acting to the bearings B1,B2, [Ns²/cm] provided that,

$${M}_{1} = M \frac{{I}_{2}}{L} , {M}_{2} = M \frac{{I}_{1}}{L} [ {Ns}^{2} / cm ] \qquad 1 \text{-} 2$$
M: mass of rotor [Ns²/cm]
C_{1,2}: viscous damping coefficient of the bearings B1,B2 [N·s/cm]
k_{1,2}: stiffness of the bearings B1,B2 in x-coordinate [N/cm]
   k_{1,2}=(ω n₁,n₂)²M_{1,2} [N/cm] 1-3
ω n₁,n₂: natural frequencies of the bearings B1,B2 in x-coordinate [rad/s]
ω: angular velocity of rotor [rad/s]
t: time [s]

The magnitudes of the unbalance centrifugal forces F₁, F₂ in rotor can be obtained by the following equation based on the solution of the Eq. 1-1
Fᵢ=kᵢxᵢ\sqrt{[1−(ω/ωₙᵢ)²]²+[2(cᵢ/c_{ci})(ω/ωₙᵢ)]²}[N] 1-4
where,
i: 1, 2, to be continued followings
C_{ci}: critical damping coefficient of the bearings B1,B2 in x-coordinate [N·s/cm]

2. As the alternate solution for the magnitudes of the unbalance centrifugal forces F₁, F₂, the unbalances distributing in the rotor can be represented at the intensive and arbitrary two planes (defined as correction planes or dynamic balance planes) being vertical to the rotationally axis (main shaft), and on the view-point of this invention that “the unbalance centrifugal forces in rotor acting to the both bearings, are equivalent to the unbalance centrifugal forces caused in the dynamic balance planes of the both portions of the journals”, because of the journals of rotor supported by the bearings are also to belong to the portion of rotor, so the magnitude [N] of the unbalance centrifugal forces F₁, F₂ can be expressed by the following equation
F_{1,2}=M_{1,2}e_{1,2}ω²[N] 2-1
where, e_{1,2}: specific unbalances at the bearing B1,B2 (journals) planes [cm]

3. The amount of specific unbalance, e_{1,2}, can be obtained by the following equation of motion which the Eq. 2-1 is substituted in Eq. 1-1

$${M}_{1 , 2} \frac{{ⅆ}^{2} {x}_{1 , 2}}{ⅆ {t}^{2}} + {c}_{1 , 2} \frac{ⅆ {x}_{1 , 2}}{ⅆ t} + {k}_{1 , 2} {x}_{1 , 2} = {M}_{1 , 2} {e }_{1 , 2} {ω}^{2} cos ω t [ N ] \qquad 3 \text{-} 1$$

Based on the solution of Eq. 3-1, the amount of specific unbalance, e_{1,2}, can be obtained by the following equation

$${e}_{1} = {x}_{1} \frac{\sqrt{{[ 1 - {( ω / {ω}_{ni} )}^{2} ]}^{2} + {[ 2 ( {c}_{i} / {c}_{oi} ) ( ω / {ω}_{ni} ) ]}^{2}}}{{( ω / {ω}_{ni} )}^{2}} [ cm ] \qquad 3 \text{-} 2$$

4. The direction of vector F₁, F₂, namely the angular position θ1, θ2 to the X-coordinate (basis) can be obtained by that the phase angles: αi are revised to the measured angular positions of the vibration vectors X₁, X₂ (displacement) for the F₁, F₂ (force) [N].

αi are expressed by the following equation

$${α}_{i} = {tan}^{- 1} \frac{2 ( ω / {ω}_{ni} ) ( {c}_{1} / {c}_{oi} )}{1 - {( ω / {ω}_{ni} )}^{2}} [ rad ] \qquad 4 \text{-} 1$$

5. Determining the dynamic unbalance of the section, b, of rotor R based on the quantities of the unbalance centrifugal force vector F₁, F₂ (magnitude, direction)at the bearings B1,B2 (journal portions) obtained by Eq. 1-4 or Eq. 2-1, can be calculated as following descriptions based on the view point of the feature of the invention that it is similar to move or change the arbitrary dynamic balance planes.

Where, the both sides of the section, b, of rotor R are two correction planes I, II (this means that the length between the correction planes I and II is ,b,) And, let the lengths between the both correction planes and the both bearings B1,B2 are a₁ and a₂ [cm], namely
Ratio of distances between bearings and correction-planes=a₁:b:a₂ [cm] 5-1

6. In case of a₁=a₂ and F₁≈F₂:

(the surface of FIG. 2 means that X-coordinate and Y-coordinate are crossing on the face, and Z-coordinate is perpendicular to the surface of FIG. 2)

The magnitudes of vectors F₁, F₂ [N] obtained by Eq. 1-4 or 2-1, 3-2, are converted to the arbitrary lengths and drew on FIG. 2.

And the length of straight line which is connected between the tips of arrows of vectors F₁, F₂ on FIG. 2, is drew as b′, then the line b′ are extended to the both outside as the a₁′ of F₁ side and a₂′ of F₂ side, and the ratio of lengths of 3-line shall be set as equal to the ratio of distances between the bearings-correction-planes of Eq. 5-1.

Namely,
a₁′:b′:a₂′=a₁:b:a₂ [cm] 6-1

7. Next on the FIG. 2, the lines F_{I}, F_{II} are drew by connecting with between the each tips of lines a₁′, a₂′ and the center of rotational axis Z, are obtained as the dynamic unbalance vectors (N, rad) of correction planes I, II in rotor that corresponding to F₁, F₂ (dynamic unbalance centrifugal forces) vectors (N,rad)

8. The magnitudes [N] of dynamic unbalance centrifugal force vectors F_{I}, F_{II} can be obtained by the following equation based on the ratio of arbitrary unit length on the FIG. 2

$${F}_{I , II} = {F}_{1 , 2} \frac{length of vector {F}_{I , II}}{length of vector {F}_{1 , 2}} [ N ] \qquad 8 \text{-} 1$$

9. The amount of specific unbalance, e_{I,II}[cm] corresponding to the dynamic unbalances F_{I}, F_{II}[N] are can be obtained by that the result of Eq. 8-1 is substituted in the following equation

$$\begin{matrix}{e}_{I} = \frac{{F}_{I}}{{M}_{I} {ω}^{2}} , {e}_{II} = \frac{{F}_{II}}{{M}_{II} {ω}^{2}} [ cm ] \\ Where , & 9 \text{-} 1 , 9 \text{-} 2 \\ {M}_{I} , {M}_{II} \text{:} {M}_{I} = \frac{{h}_{II}}{b} M , {M}_{II} = \frac{{h}_{I}}{b} M [ {Ns}^{2} / cm ] & 9 \text{-} 3 , 9 \text{-} 4\end{matrix}$$

10. Dynamic unbalance in the case of change for the distance, b, between two correction planes I, II in the rotor on FIG. 1, (which will be changed to half distance ½b), on FIG. 2, the length: b′ is not changed, the line at F₁ side will be extended as a₁″ and also the line at F₂ side will be extended as a₂″. As result, the ratio of the three changed lines shall be satisfied within the ratio of following equation.

Namely,
a₁″:b′:a₂″=(a₁+(¼)b):(½)b:(a₂+(¼)b) 10-1

11. Then, on FIG. 2, the each tips of the lines a₁″, a₂″ and the center of rotational axis, Z are connected, and the lines F_{I}′, F_{II}′ can be produced.

The lines F_{I}′, F_{II}′ are obtained as the dynamic unbalance vectors (ratio of magnitude, angle position) corresponding to F₁, F₂ (unbalance centrifugal forces) [N,rad] at the correction planes I, II, in case of the distance between 2-correction planes in rotor has been changed to ½ of ,b,

12. The amounts of specific unbalance of dynamic unbalance, e_{I}′, e_{II}′ [cm] in case of the distance: ½b between the 2-correction planes which can be obtained by the simulating calculation in accordance with Eqs. 8-1, 9-1, and 9-2.

13. In case of a₁≠a₂:

The calculation to determine the dynamic unbalance can be performed that the dynamic unbalance vectors: F_{I}, F_{II}[N] obtained by above Par. 6˜9 (in case of a₁=a₂) are distributed to the designed correction planes in accordance with the conventional method of statics, and the dynamic unbalance vectors of the each designed plane can be determined by the geometric re-addition of these distributed vectors.

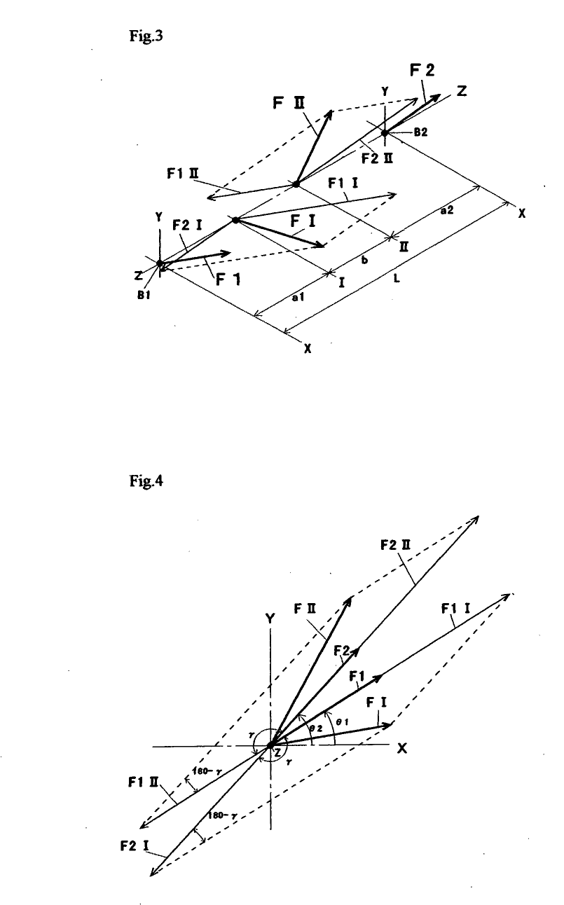

And in case of the directly calculating to determine the dynamic unbalance from the unbalance centrifugal forces vectors F₁, F₂ [N], based on the view-point “the planes of both journals (bearings) are also equal to dynamic balance plane in rotor”, the dynamic unbalance vectors F_{I}, F_{II} [N] of rotor can be determined in following Pars. by the vector-geometric-calculation using principles of statics as showing in FIG. 3 ( three-dimensional drawing) and FIG. 4.

14. At first, as showing FIG. 3 (three-dimensional drawing), the original magnitude F₁, F₂ [N] are distributed to the designed dynamic balance plane (correction planes) I, II by the following equation

And the magnitudes of component vectors can be obtained.
component vectors on F₁ plane:

$${F}_{1 I} = {F}_{1} \frac{{a}_{1} + b}{b} , {F}_{2 I} = {F}_{2 II} \frac{{a}_{2}}{b + {a}_{2}} [ N ] \qquad \text{14-1,14-2}$$
component vectors on F_{II} plane:

$${F}_{1 II} = {F}_{1 I} \frac{{a}_{1}}{{a}_{1} + b} , {F}_{2 II} = {F}_{2} \frac{b + {a}_{2}}{b} [ N ] \qquad \text{14-3,14-4}$$

15. Next, the resultant vector F₁ from the component vectors of Eqs. 14-1,2 and the resultant vector F_{II} from the component vectors of Eqs. 14-3,4 are showed on FIG. 4 as the dynamic unbalance vectors of the dynamic balance planes I, II, namely, the dynamic unbalance vectors F_{I}, F_{II} of the dynamic balance planes I, II can be obtained by the vector-calculation based on “parallelogram law” showed in FIG. 4 or the following equations according to the formulas of “triangle of force”. Namely,
F_{I}=\sqrt{F_{1I}²+F_{2I}²−2F_{1I}F_{2I} COS (180−τ)} [N] 15-1
F_{II}=\sqrt{F_{1II}²+F_{2II}²−2F_{1II}F_{2II} COS (180−τ)} [N] 15-2
provided that,
τ=(θ₁+180)−θ₂ [deg] 15-3

16. The amounts of specific unbalance e_{I}, e_{II} [cm] corresponding to the dynamic unbalance centrifugal force F_{I}, F_{II} [N] determined in the above Par. 15, which can be obtained by simulating in accordance with Eqs. 8-1,9-1,and 9-2. Showing in the above descriptions of “Best mode of carrying out the invention”, the calculation procedures with the equations and geometric calculations with vector in FIGS. 2 and 4, which are the features of this invention.

And the numeric calculation used with the trigonometrical function and the sine and cosine law of trigonometry that simulated with the geometric calculations with vector in FIGS. 2 and 4, which are also valid in this invention.

And these calculation mode can be applied the vectors measured for the velocity and acceleration and for the computer of field balancing and dynamic balancing machines, which are also valid in this invention.

Possibility on the Industrial Utilization:

This invention can directly calculate to determine the dynamic unbalance of rotating machine from the original vibration vectors detected at the bearings. Therefor the test runs which are subject to detect the changes effected with the trial masses in field balancing, they are unnecessary, so the dynamc balancing works can be simplified and reduced in measuring time.

The merits due to reduction increase according to the more larger size rotor.

And this invention makes easily to correct the unbalance, to test balancing and to monitor for the unbalance vibration in the areas of the chemical plants, nuclear power plants and such plants using dangerous objects, and to contribute for the safety. On the dynamic balancing test at the shop of rotating machinery, the application of this invention makes to reduce the measuring times and to simplify the methods and procedures for measuring, and to be valid to reduce for burdens of the powers, labors, and equipments.

1. The calculating method to determine the dynamic unbalance in rotors by the vector calculation which is using with the ratios between the distance lengths of bearings of machines and apparatus and the ratios of the distance length of arbitrarily chosen two correction planes without the test runs attached with trial masses, based on the data consist of magnitudes and directions for the vibration vector quantities of displacement, velocity, or acceleration which originated in dynamic unbalance in rotor, and which are measured at the two bearings of the rotating machines or dynamic balancing machines

2. The computers, measuring instruments and testing facilities, which are directly or indirectly applied or equipped the calculating method to determine the dynamic unbalance in rotor with the vector calculation mentioned in the claim 1.
